(19) United States
(12) Patent Application Publication
(10) Pub. No.: US 2016/0031101 A1
(43) Pub. Date: Feb. 4, 2016

(54) Razor

(71) Applicant: Willie Fulton, Pine Bluff, AR (US)

(72) Inventor: Willie Fulton, Pine Bluff, AR (US)

(21) Appl. No.: 14/817,528

(22) Filed: Aug. 4, 2015

Related U.S. Application Data
(60) Provisional application No. 62/032,689, filed on Aug. 4, 2014.

(51) Int. Cl. B26B 21/22; B26B 21/40

(52) U.S. Cl. CPC B26B 21/222; B26B 21/4062

(57) ABSTRACT

A razor configured to achieve a close shave is provided. The razor includes a handle having an upper end and a lower end, wherein the upper end includes a mounting bracket configured to support a razor head thereon. The razor head includes a plurality of blades configured to rotate about in an oval loop driven by a rotating assembly. The razor head includes a pair of support structures disposed on opposing ends of the mounting bracket in a parallel configuration. Each support structure includes a pair of rotors configured to allow a conveyer belt to loop therearound. The conveyer belts are connected together via a plurality of blades disposed in a horizontal orientation. The conveyer belts are configured to be rotated in unison via a motor from the rotating assembly. The rotating assembly also includes an activation switch, a rotation switch and a speed switch.

### CROSS REFERENCE TO RELATED APPLICATION

This application claims the benefit of U.S. Provisional Application No. 62/032,689 filed on Aug. 4, 2014. The above identified patent application is herein incorporated by reference in its entirety to provide continuity of disclosure.

### FIELD OF THE INVENTION

The present invention relates to grooming accessories. Specifically, the present invention relates to a razor having a rotating assembly configured to rotate a plurality of blades in an oval loop to achieve a close shave for users.

### BACKGROUND OF THE INVENTION

For many people, shaving is a common occurrence. One of the common goals while shaving is to achieve a close shave, wherein the stubbles are practically invisible to others. However, trying to achieve a close shave can result in razor burn, ingrown hairs, and razor bumps, as well as lead to nicks and cuts when a person sweeps across an area of skin in an awkward manner. Therefore, for many people, shaving is often a nuisance and an undesirable chore.

There are a variety of popular principles that are outlined for people to follow to achieve a close shave. These principles include using a sharp blade, which is essential to a close shave. Unfortunately, conventional blades only include a few blades that dull rather quickly because of the continuous wear and tear on the blades. Purchasing replacements blades routinely to achieve a close shave can become quite expensive. Therefore, there exists a need for a disposable razor, wherein the lifetime of the blades can be prolonged, thereby delaying the purchasing of replacement blades.

Devices have been disclosed in the prior art that relate to disposable razors having a rotational mechanism. These include devices that have been patented and published in patent application publications. Some of these devices provide razors having one or more rotatable and perforated cylindrical supports having a blade thereon. Other devices provide an electric razor with a cylindrical driving shaft having a plurality of cutting blades therearound. These devices, however, fail to provide a razor head having a pair of conveyor belts configured to rotate a plurality of blades in an oval loop.

The present invention provides a razor having a handle with an upper end and a lower end. The upper end includes a mounting bracket configured to secure a razor head thereto. The razor head includes a plurality of blades rotated in an oval loop via a rotating assembly. The razor head includes a pair of support structures disposed on opposing ends of the mounting bracket in a parallel configuration. Each support structure includes a pair of rotors configured to allow a conveyer belt be looped therearound. The conveyer belts are connected together via a plurality of blades attached thereon in a horizontal orientation, wherein the plurality of blades are configured to rotate around in an oval loop via a motor configured to rotate the rotors in unison.

It is therefore submitted that the present invention is substantially divergent in design elements from the prior art, and consequently it is clear that there is a need in the art for an improvement to razors. In this regard, the instant invention substantially fulfills these needs.

### SUMMARY OF THE INVENTION

In view of the foregoing disadvantages inherent in the known types of razors now present in the prior art, the present invention provides a razor, wherein the same can be utilized for providing a user with a closer shave than conventional razors.

It is therefore an object of the invention to provide a new and improved razor that has all of the advantages of the prior art and none of the disadvantages.

Another object of the present invention is to provide a new and improved razor having a handle with an upper and lower end, wherein the upper end includes a mounting bracket configured to removably fasten a razor head thereon.

Yet another object of the present invention is to provide a new and improved razor, wherein the razor head includes a plurality of blades thereon configured to be rotated about in an oval loop via a rotating assembly.

Still yet another object of the present invention is to provide a new and improved razor, wherein the razor head includes a pair of support structures, wherein each support structure is disposed on opposing ends of the mounting bracket in a parallel configuration.

Another object of the present invention is to provide a new and improved razor, wherein each support structure includes a pair of rotors having a conveyer belt looped therearound. A plurality of blades are disposed in a horizontal orientation configured to connect the pair of support structures to one another.

Yet a further object of the present invention is to provide a new and improved razor, wherein the pair of conveyer belts is rotated about said pair of rotors in unison via a motor in the rotating assembly, thereby rotating said plurality of blades thereabout.

Still yet another object of the present invention is to provide a new and improved razor, wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side perspective view of the present invention.

FIG. 2 shows a side perspective view of the present invention with the razor head of the present invention separated.

FIG. 3 shows a schematic diagram of the present invention.

### DETAILED DESCRIPTION OF THE INVENTION

Reference is made herein to the attached drawings. Like reference numerals are used throughout the drawings to depict like or similar elements of the razor. For the purposes of presenting a brief and clear description of the present invention, the preferred embodiment will be discussed as used for providing a clean shave for a user. The figures are intended for representative purposes only and should not be considered to be limiting in any respect.

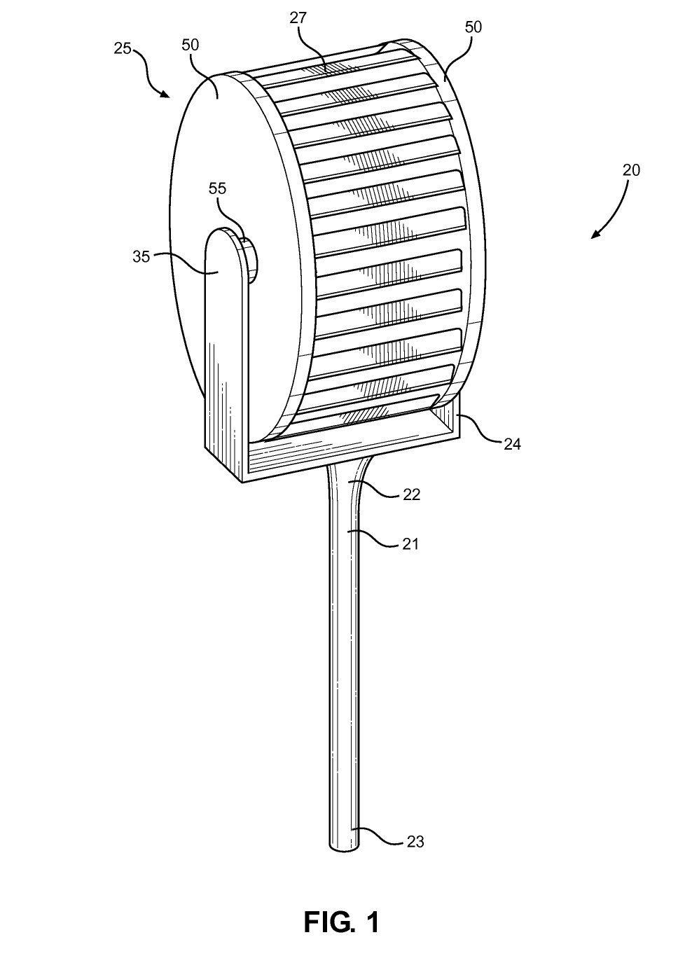

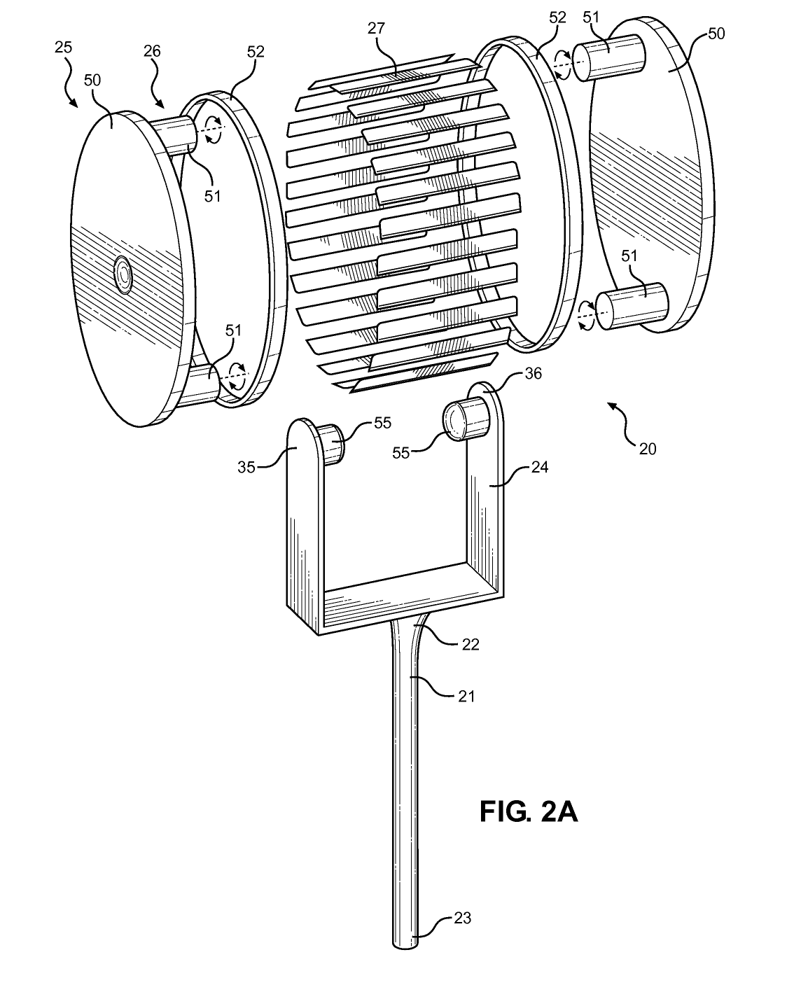

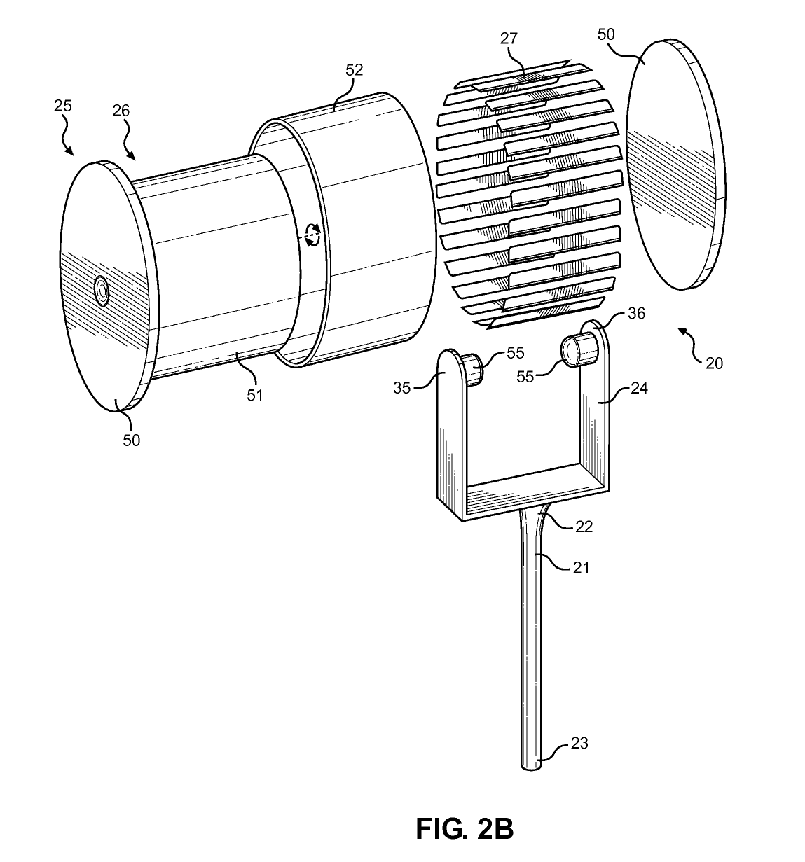

Referring now to FIGS. 1, 2A and 2B, there are shown several side perspectives of the razor 20. The razor 20 includes a handle 21 having an upper end 22 and a lower end 23. The lower end 23 is configured to be grasped by a user so that the user can hold the handle 21 in one hand. The upper end 22 includes a U-shaped mounting bracket 24 having opposing ends 35, 36 configured to removably attach a razor head 25. The razor head 25 includes a rotating assembly 26 that is configured to rotate a plurality of blades 27 around the razor head 25 to provide for a cleaner shave than a conventional razor.

The razor head 25 includes a pair of support structures 50, wherein the pair of support structures 50 are disposed on opposing ends 35, 36 of the mounting bracket 24 in a parallel configuration. The opposing ends 35, 36 each includes a fastener 55 configured to allow one of the pair of support structures 50 of the razor head 25 to be attached to the mounting bracket 24. Preferably, each support structure 50 is oval-shaped, however, other shapes and sizes are likewise contemplated. FIGS. 2A and 2B refer to two preferred embodiments of the razor 20. As illustrated in FIG. 2A, each support structure 50 also includes at least a pair of rotors 51 thereon configured to allow a conveyor belt 52 to be looped therearound to form an oval loop. Each conveyer belt 52 is situated in a parallel manner from one another and separated by the space spanning the opposing ends 35, 36 of the mounting bracket 24. In the alternative embodiment illustrated in FIG. 2B, each support structure 50 are connected via a pair of rotors 51 therebetween configured to allow a wider conveyor belt 52 to be looped therearound to form an oval loop.

The plurality of blades 27 are disposed on the pair of conveyer belts 52 (or conveyor belt 52 in the alternative embodiment) in a horizontal orientation, thereby connecting the pair of conveyer belts 52 to one another. The plurality of blades 27 are configured to rotate about the oval loop shape of the pair of conveyer belts 52. In addition, the plurality of blades 27 are evenly spaced apart from one another in a parallel manner to allow for a close shave Further, each blade 27 is angled to cut and are identical to one another.

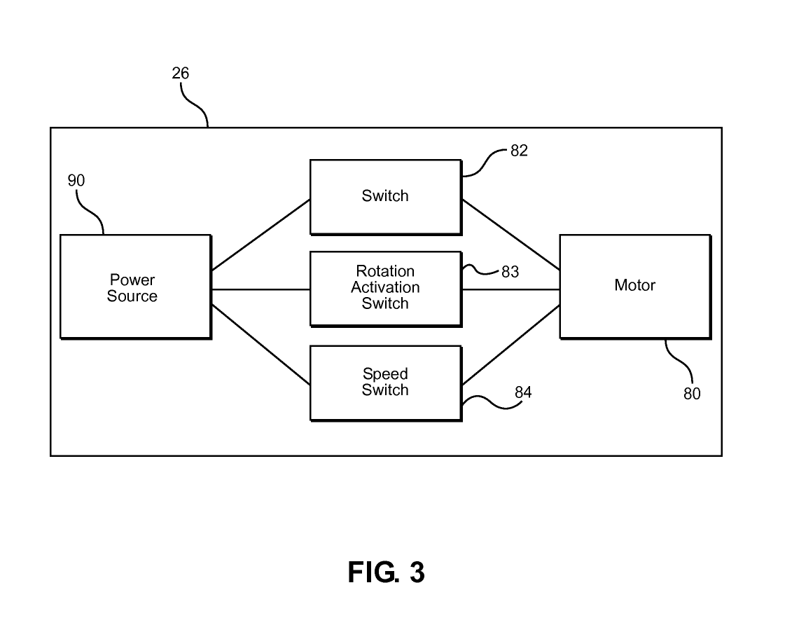

Referring now to FIG. 3, there is shown a schematic diagram of the rotating assembly of the razor. The rotors are driven by a motor 80 of the rotating assembly 26 configured to rotate the pair of conveyer belts in unison, thereby allowing the plurality of blades to rotate about the pair of conveyer belts in an oval loop. The rotating assembly 26 is electrically connected to a switch 82 that is configured to activate the rotating assembly. Preferably, the switch 82 is a depressible button, however, other suitable switches can be interchanged with the switch 82 without altering the spirit and scope of the present invention.

The rotating assembly 26 also includes a power source 90 that is configured to provide voltage to the rotating assembly 26. The power source 90 is preferably a rechargeable battery, however other suitable alternatives are also likewise contemplated. The switch 82 is configured to complete a circuit between the rotating assembly 26 and the power source 90, thereby providing voltage to electrically power the rotating assembly 26. The rotating assembly 26 is particularly advantageous as it allows a user to achieve a closer shave by having the plurality of blades 27 rotate about the conveyer belts.

In addition, the rotating assembly 26 also includes a rotation activation switch 83 that is configured to allow for the plurality of blades to be actuated in a clockwise or counterclockwise manner. In this way, the user can select to shave with the grain or against the grain. In some embodiments, the rotating assembly 26 also includes a speed switch 84 that is configured to allow a user to select the rotation speed of the plurality of blades. The motor 80 is configured to rotate the rotors more quickly, thereby allowing the plurality of blades disposed on the conveyer belts to be rotated about in a desired speed. This is particularly beneficial as certain circumstances may require a faster rotation, while other circumstances may require a slower rotation to decrease the likelihood of nicks, razor burn and ingrown hairs.

It is therefore submitted that the instant invention has been shown and described in what is considered to be the most practical and preferred embodiments. It is recognized, however, that departures may be made within the scope of the invention and that obvious modifications will occur to a person skilled in the art.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A razor, comprising:
a handle having an upper end and a lower end, wherein said upper end includes a mounting bracket;
a razor head having a plurality of blades and a rotating assembly configured to be attached to said mounting bracket;
wherein said rotating assembly is configured to rotate said plurality of blades in an oval loop.

2) The razor of claim 1, wherein said mounting bracket is substantially U-shaped and includes opposing ends.

3) The razor of claim 2, wherein said opposing ends each includes a fastener configured to fasten said razor head thereon.

4) The razor of claim 1, wherein said razor head includes a pair of support structures aligned in a parallel configuration separated by a space in between said pair of support structures.

5) The razor of claim 4, wherein each of said pair of support structures is disposed on said opposing ends of said mounting bracket via one of said fasteners.

6) The razor of claim 4 wherein each of said pair of support structures includes a pair of rotors.

7) The razor of claim 6, wherein each said pair of rotors includes a conveyer belt configured to loop therearound.

8) The razor of claim 7, wherein said plurality of blades are disposed in a horizontal orientation on each said conveyer belt thereby connecting said pair of support structures to one another.

9) The razor of claim 7, wherein said rotating assembly includes a motor configured to rotate each said pair of rotors in unison, thereby actuating each said conveyer belt in unison.

10) The razor of claim 1, wherein said rotating assembly further includes an activation switch configured to provide electrical power from a power source to said rotating assembly.

11) The razor of claim 1, wherein said rotating assembly further includes a rotation activation switch configured to allow a user to select a clockwise rotation or counterclockwise rotation of said plurality of blades.

12) The razor of claim 1, wherein said rotating assembly further includes a speed switch configured to allow a user to select a speed of rotation.

13) The razor of claim 4, wherein said plurality of razors span said space between said pair of support structures.

14) The razor of claim 4, a pair of rotors extend between said pair of support structures.

15) The razor of claim 14, wherein said pair of rotors includes a conveyer belt configured to loop therearound.

16) The razor of claim 15, wherein said plurality of blades are disposed in a horizontal orientation on said conveyer belt thereby connecting said pair of support structures to one another.

17) The razor of claim 15, wherein said rotating assembly includes a motor configured to rotate said pair of rotors in unison, thereby actuating said conveyer belt in unison.
